(19) United States
(12) Patent Application Publication
(10) Pub. No.: US 2009/0180158 A1
(43) Pub. Date: Jul. 16, 2009

(54) ORIGINAL READING APPARATUS

(76) Inventor: Yasuhiro Suto, Nara (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/351,168

(22) Filed: Jan. 9, 2009

(30) Foreign Application Priority Data
Jan. 15, 2008 (JP) 2008-005965

(51) Int. Cl. H04N 1/04

(52) U.S. Cl. 358/474

(57) ABSTRACT

One embodiment of an original reading apparatus is provided with an original scanning portion, an intermediate scanning portion, and an original size sensor arranged on the intermediate scanning portion so as to face a platen, and in a standby state before reading an original, a state is achieved in which the original scanning portion is positioned near an upstream side of an effective original reading region in a sub-scanning reading direction and the intermediate scanning portion is positioned near the center of the effective original reading region in the sub-scanning direction and, in this state, detection of the size of the original is carried out by the original size sensor before reading the original.

### BACKGROUND OF THE INVENTION

This application claims priority under 35 U.S.C. §119(a) on Patent Application No. 2008-5965 filed in Japan on Jan. 15, 2008, the entire contents of which are herein incorporated by reference.

The present invention relates to original reading apparatuses that read an image of an original by optically scanning the original placed on a platen.

Some conventional original reading apparatuses use original size sensors to automatically detect a size of an original placed on the platen. In image forming apparatuses, such as copiers and multifunction machines, and external devices such as computers or the like connected to these original reading apparatuses, settings are performed relating to original size information, such as determinations of scaling ratios and determinations of a data size of the image of the original for example, according to the size of the original detected by the original reading apparatus.

In this regard, in order to accurately detect the size of the original, it is preferable for the original size sensors (in particular, reflective type optical sensors that detect reflected light from the original) to be as close as possible to the original on the platen.

Patent document 1 (JP S62-124545A) proposes a technique in which a scanning portion, which is provided with a light source that optically illuminates the original on the platen and a reflection portion that guides in a predetermined direction the reflected light from the original, which has been optically illuminated by the light source, is initially moved before reading an image of the original, and the size of the original is detected by original size sensors provided in the scanning portion, and the scanning portion is again moved when reading an image of the original.

However, in a case where original size sensors are provided on the scanning portion having a light source and a reflection portion as in the technique described in the above-mentioned patent document 1, it is necessary to initially move the scanning portion to detect the size of the original, and therefore there is a disadvantage in that a quick transition cannot be made to the process of reading the original after the original has been placed on the platen.

### SUMMARY OF THE INVENTION

An object of the present invention is to provide an original reading apparatus that is capable of accurately and quickly detecting the size of an original before reading the original, and in this way is capable of carrying out the process of reading the original without delay.

In order to address these issues, the present invention includes an original reading apparatus that reads an image of an original by optically scanning the original placed on a platen, provided with: an original scanning portion, which is provided with a light source that optically illuminates the original on the platen and a first reflection portion that guides reflected light in a predetermined direction from the original, which has been optically illuminated by the light source, and is configured so as to move in a sub-scanning direction along the platen, and an intermediate scanning portion, which is provided with a second reflection portion that guides reflected light of the original from the original scanning portion to an image reading portion, and is configured to operate together with sub-scanning direction movement of the original scanning portion so as to move in the sub-scanning direction along the platen, wherein the intermediate scanning portion is provided with an original size sensor arranged so as to face the platen, and in a standby state before reading the original, a state is achieved in which the original scanning portion is positioned near an upstream side of an effective original reading region in a sub-scanning reading direction and the intermediate scanning portion is positioned near the center of the effective original reading region in the sub-scanning direction and, in this state, detection of the size of the original is carried out by the original size sensor before reading the original.

With the original reading apparatus according to the present invention, the original size sensor is provided on the intermediate scanning portion so as to face the platen, and therefore an original placed on the platen and the original size sensor can be in close vicinity to each other, and this enables the size of the original to be detected with excellent accuracy. Further still, in a standby state before reading the original, a state is achieved in which the original scanning portion is positioned near the upstream side of the effective original reading region in the sub-scanning reading direction and the intermediate scanning portion is positioned near the center of the effective original reading region in the sub-scanning direction and, in this state, detection of the size of the original is carried out by the original size sensor before reading the original, and therefore it is not necessary to move the scanning portions to detect the size of the original, and this enables a quick transition to be made to the process of reading the original after the original is placed on the platen and the size of the original is detected.

For example, a reflective type optical sensor that detects reflected light from an original may be used for the original size sensor. An original reading apparatus according to the present invention is particularly effective when a reflective type optical sensor is used.

An example of an original reading apparatus according to the present invention can be put forth in which a plurality of the original size sensors are arranged in a row on the intermediate scanning portion along a main scanning direction in an area facing the platen. In this case, detection of the size of the original in the main scanning direction can be carried out effectively.

Furthermore, an original reading apparatus according to the present invention may be further provided with a reflective type original size sensor for sub-scanning direction detection that detects the size of the original in the sub-scanning direction. In this case, the size of the original in the sub-scanning direction can also be detected. An example can be put forth of an embodiment in which the reflective type original size sensor for sub-scanning direction detection is arranged at a bottom surface of the original reading apparatus.

### BRIEF DESCRIPTION OF THE DRAWINGS

FIG. 1 is a perspective view showing internal mechanisms of an original reading apparatus according to one working example of the present invention.

FIG. 2A and 2B are explanatory diagrams that schematically show a mechanical configuration of the original reading apparatus shown in FIG. 1, with FIG. 2A showing a state before reading an original and FIG. 2B showing a state after reading the original.

FIG. 3 is a system block diagram centrally showing the control portion of the original reading apparatus shown in FIG. 1.

FIG. 4 is a diagram for describing an operation principle of original size detection.

FIG. 5 is a diagram for describing specifying the size of an original.

### DESCRIPTION OF THE PREFERRED EMBODIMENTS

Hereinafter, an embodiment of the present invention is described with reference to the accompanying drawings. It should be noted that the following working example is a single specific example of the present invention and is not of a nature that limits the scope of the present invention.

Outline of Original Reading Apparatus 1

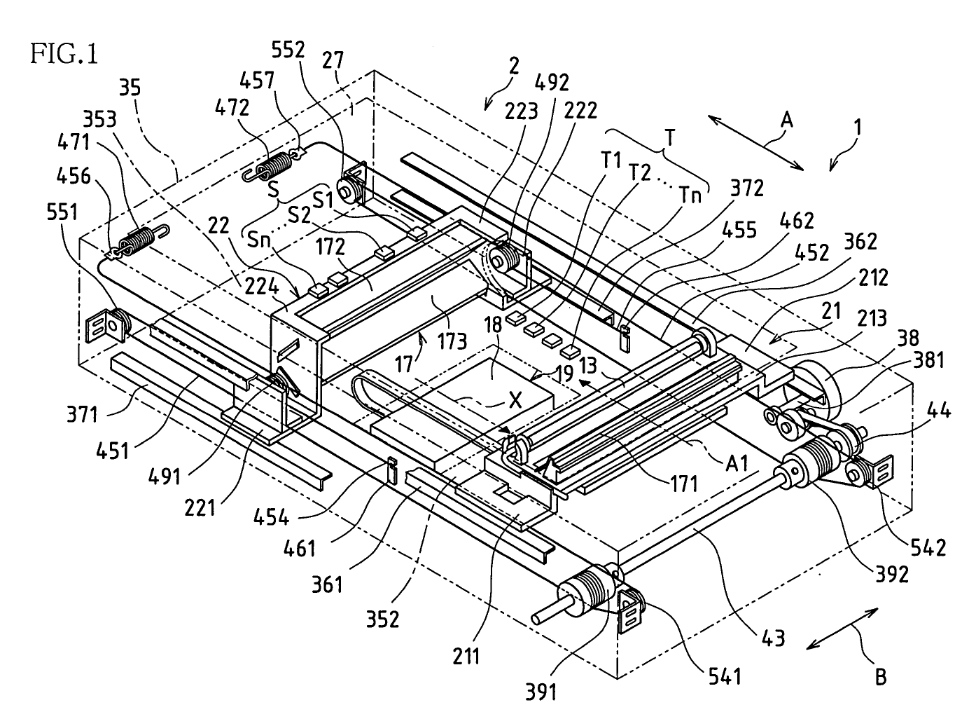

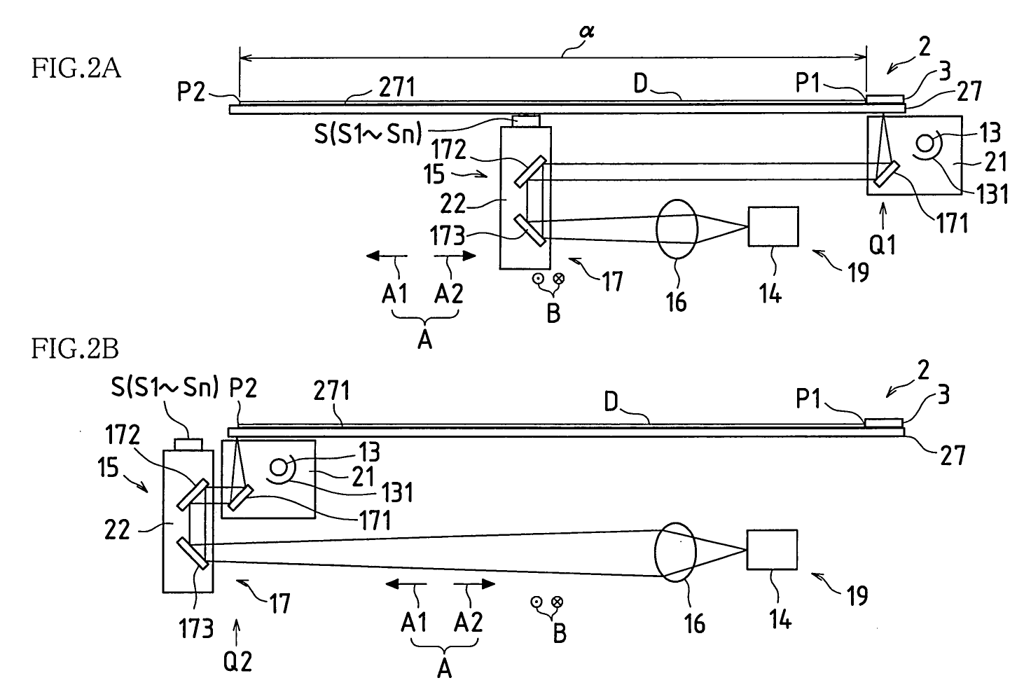

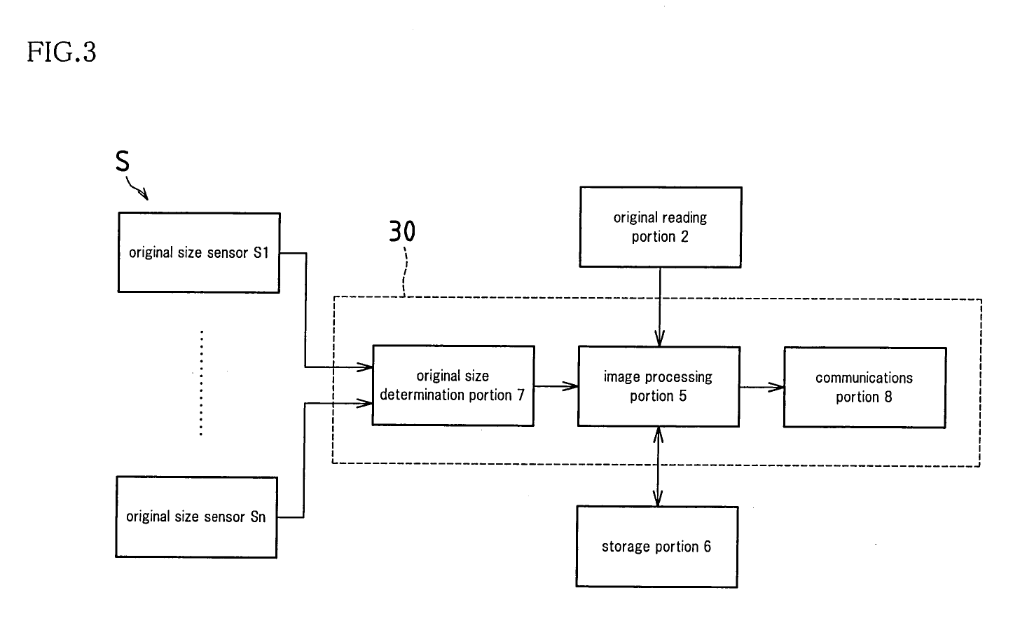

FIG. 1 is a perspective view showing internal mechanisms of an original reading apparatus 1 according to one working example of the present invention. It should be noted that an overall configuration of the original reading apparatus 1 and functions achieved by an original reading portion 2 therein are described in detail later with reference to FIGS. 2A and 2B and FIG. 3.

As shown in FIG. 1, the original reading portion 2 in the original reading apparatus 1 reads an image of an original by optically scanning an original D (not shown in FIG. 1, see FIG. 2A and 2B) placed on a platen 27 in a main scanning direction (B direction in FIG. 1) along the platen 27 and a sub-scanning direction (A direction in FIG. 1) along the platen 27 orthogonal to the main scanning direction B.

The original reading portion 2 is provided with the platen 27, a first scanning unit 21, a second scanning unit 22, and an image reading portion 19.

The first scanning unit 21 is provided with a light source 13 and a first mirror 171. The light source 13 optically illuminates the original D on the platen 27. The first mirror 171 guides reflected light from the original D, which has been optically illuminated by the light source 13, to the second scanning unit 22. Then the first scanning unit 21 moves reciprocally in the sub-scanning direction A along the platen 27.

The second scanning unit 22 is provided with second and third mirrors 172 and 173 and a mirror support portion 223.

The second mirror 172 and the third mirror 173 guide reflected light of the original from the first mirror 171 of the first scanning unit 21 to the image reading portion 19. The mirror support portion 223 supports the second and third mirrors 172 and 173, and has a surface 224 facing the platen 27. The image reading portion 19 here is provided with an image forming lens 16 and an imaging device 14 (not shown in FIG. 1, see FIG. 2A and 2B). The first through third mirrors 171 to 173 and the image forming lens 16 constitute an image forming optical system 15.

And the second scanning unit 22 operates together with the reciprocal movement in the sub-scanning direction A of the first scanning unit 21 and moves reciprocally in a same direction as the first scanning unit 21.

Overall Configuration of the Original Reading Apparatus 1

FIG. 2A and 2B are explanatory diagrams that schematically show a mechanical configuration of the original reading apparatus 1 shown in FIG. 1. First, further detailed description is given regarding the original reading portion 2 with reference to FIG. 1 and FIGS. 2A and 2B. A surface 353 facing the platen 27 of casing that covers the first and second scanning units 21 and 22 constitutes a bottom surface of the original reading apparatus 1. Specifically, a flat shaped bottom panel 352 is installed at a bottom portion of a frame 35 that constitutes an outer frame of the original reading portion 2. The bottom panel 352 is provided with the surface 353 facing the platen 27. The image forming lens 16 and the imaging device 14 are installed at an area covered by a dark chamber 18 on the bottom panel 352.

An arrow X described with a dashed dotted line on the dark chamber 18 is a direction of an optical axis of the image forming lens 16 installed on the frame 35. For example, a steel plate having a zinc coating on a front surface can be used for the frame 35 and the bottom panel 352. The first scanning unit 21 and the second scanning unit 22 move along the bottom panel 352 and the platen 27 between the bottom panel 352 and the platen 27 to pass above the dark chamber 18. It should be noted that the first scanning unit 21 is one example of an original scanning portion referred to in the present invention and the second scanning unit 22 is one example of an intermediate scanning portion referred to in the present invention.

The first scanning unit 21 is provided with wire securing portions 211 and 212 arranged at end portions in the main scanning direction B and a mirror support portion 213 that supports the light source lamp 13 and the first mirror 171 such that they are disposed along the main scanning direction B in a central area of the main scanning direction B. The first mirror 171 constitutes a first reflection portion referred to in the present invention. A driving wire 451 is secured to the wire securing portion 211 and a driving wire 452 is secured to the wire securing portion 212. Furthermore, the end portions in the main scanning direction B of the first scanning unit 21 are supported by guide rails 361 and 362 respectively, which are arranged along the sub-scanning direction A, and are configured so as to be capable of slidably moving in the sub-scanning direction A on the guide rails 361 and 362. An arrow Al described with a dashed dotted line at a central area of the first scanning unit 21 indicates a movement direction toward one side of the sub-scanning direction A of the first scanning unit 21. The movement direction A1 is a sub-scanning reading direction Al referred to in the present invention (a direction of moving for the first scanning unit 21 to read an image of the original). The driving wires 451 and 452 secured at the main scanning direction B end portions of the first scanning unit 21 span support pulleys 541 and 542, which are arranged at one end portion in the sub-scanning direction A, and support pulleys 551 and 552 arranged at another end portion in the sub-scanning direction A respectively.

The second scanning unit 22 is provided with wire securing portions 221 and 222 arranged at end portions in the main scanning direction B and the mirror support portion 223 that supports the second mirror 172 and the third mirror 173 in a central area of the main scanning direction B. The second mirror 172 and the third mirror 173 constitute a second reflection portion referred to in the present invention. A pulley 491 is installed on the wire securing portion 221, and the driving wire 451 is wound onto the pulley 491. A pulley 492 is installed on the wire securing portion 222, and the driving wire 452 is wound onto the pulley 492. And one end portions 454 and 455 of the driving wires 451 and 452 latch onto latching portions 461 and 462 respectively, which are supported at the bottom panel 352, and other end portions 456 and 457 are attached to the frame 35 via springs 471 and 472 respectively. Furthermore, the end portions in the main scanning direction B of the second scanning unit 22 are supported by guide rails 371 and 372 respectively, which are arranged along the sub-scanning direction A, and are configured so as to be capable of slidably moving in the sub-scanning direction A on the guide rails 371 and 372. And the second scanning unit 22 is configured to move in a same direction as the first scanning unit 21.

A drive motor 38 is a stepping motor that drives the first scanning unit 21 and the second scanning unit 22, and is configured to enable the first and second scanning units 21 and 22 to move reciprocally in the sub-scanning direction A by having its rotation operations controlled by an unshown motor control circuit. Rotational drive of an output shaft 381 of the drive motor 38 is transmitted to a drive shaft 43 via a timing belt 44, and drive pulleys 391 and 392 attached at the end portions of the drive shaft 43 can be rotated by rotating the drive shaft 43. The driving wires 451 and 452 are wound onto the drive pulleys 391 and 392 respectively and, moreover, the driving wires 451 and 452 are secured to the first scanning unit 21 and the second scanning unit 22 respectively. Rotation of one direction or the other direction of the drive pulleys 391 and 392 is converted to linear reciprocating motion by the driving wires 451 and 452, and in this manner the first scanning unit 21 and the second scanning unit 22 are capable of moving reciprocally in the sub-scanning direction A. It should be noted that it is preferable for steel components to be used for the drive shaft 43 and the drive pulleys 391 and 392, and it is preferable for steel wire to be used for the driving wires 451 and 452.

Next, description is given below regarding an overall configuration of the original reading apparatus 1. As described earlier, the original reading portion 2 is provided with the platen 27, which has an original placement surface 271, the light source 13 that illuminates an original D placed on the original placement surface 271, the imaging device 14 that receives light from the original D, which is illuminated by the light source 13, and the image forming optical system 15 that performs image forming of the light from the original D onto the imaging device 14. The platen 27 is constituted by a transparent glass and is formed in a rectangular panel shape. The original placement surface 271 is a surface on an upper side in a thickness direction of the platen 27. The original D to be read is placed on the original placement surface 271 by a user of the original reading apparatus 1. A reflection panel 131 that focuses light from the light source 13 onto the original placement surface 271 is arranged surrounding the light source 13. The light source 13, the imaging device 14, and the image forming optical system 15 are disposed on an opposite side of the original placement surface 271 with respect to the platen 27. For example, a charge coupled device (CCD) may be used as the imaging device 14.

The image forming optical system 15 has the image forming lens 16, which performs image forming onto the imaging device 14, and a mirror group 17 that guides light from the original D to the image forming lens 16. For example, a component in which a plurality of lenses are secured on a substantially cylindrical frame member may be used as the image forming lens 16. For example, a member such as a resin containing aluminum or glass or the like may be used as the frame member. The mirror group 17 is constituted by the first mirror 171, the second mirror 172, and the third mirror 173. As described earlier, the first mirror 171 is mounted together with the light source 13 on the first scanning unit 21, and the second mirror 172 and the third mirror 173 are mounted on the second scanning unit 22.

By being driven under the direction of a control portion 30, which is described later, by a drive system constituted by the drive motor 38, the pulleys 391, 392, 491, 492, 541, 542, 551, and 552, and the wires 451 and 452, the first scanning unit 21 moves at a constant velocity V in the direction of arrow Al (sub-scanning reading direction). The second scanning unit 22 is positioned on a downstream side of the first scanning unit 21 in the sub-scanning reading direction Al, and moves in the sub-scanning reading direction A1 at half the velocity (V/2) of the velocity V movement in the sub-scanning reading direction A1 of the first scanning unit 21 by being driven by the drive system. Here, the sub-scanning direction A includes both directions of the sub-scanning reading direction A1 and an opposite direction (direction of arrow A2 in FIG. 2A and 2B) to the sub-scanning reading direction A1.

In the original reading portion 2 provided with this configuration, light illuminated from the light source 13 is diffusely reflected by the front surface of the original D placed on the original placement surface 271 and is reflected downward from the surface (light illumination surface) of the original D. The light reflected downward from the surface of the original D is reflected by the first mirror 171, then reflected in order by the second mirror 172 and the third mirror 173 and guided to the image forming lens 16. Then, accompanying movement of the first scanning unit 21 and the second scanning unit 22, the mirror group 17 is moved along the platen 27. A reading position on the original D in the sub-scanning direction A for which image forming is performed onto the imaging device 14 moves from a scanning commencement end P1 to a scanning completion end P2 along with movement of the mirror group 17 due to the movement of the first and second scanning units 21 and 22. A velocity ratio of the first scanning unit 21 and the second scanning unit 22 during movement is maintained at 2:1, and therefore an optical path length from the surface of the original to the image forming lens 16 is maintained constant. Due to this, image forming can be performed stably of the image of the original D on the original placement surface 271 onto the imaging device 14 at each reading position from the scanning commencement end P1 to the scanning completion end P2.

FIG. 2A shows a state before reading the original, which is a state in which an optical axis position from the original D of the first scanning unit 21 toward the first mirror 171 is in a sub-scanning starting position Q1 on an upstream side (outer side) in the sub-scanning reading direction A1 from the scanning commencement end P1. And FIG. 2B shows a state after reading the original, which is a state in which the optical axis position from the original D of the first scanning unit 21 toward the first mirror 171 is in a sub-scanning stopping position Q2 on an downstream side (outer side) in the sub-scanning reading direction A1 from the scanning completion end P2. It should be noted that in FIG. 2A and 2B, a direction indicated by symbol B (direction perpendicular to the paper surface) shows the main scanning direction.

Here, a reference white plate 3 for shading correction is provided further on the upstream side in the sub-scanning reading direction Al from the scanning commencement end P1. And the sub-scanning starting position Q1 is positioned so as to be capable of reading a lower surface of the reference white plate 3. The first scanning unit 21 is configured to be capable of carrying out shading correction by performing image forming of an image of the reference white plate 3 onto the imaging device 14 at a reading position (sub-scanning starting position Q1) of the reference white plate 3.

Furthermore, a position sensor not shown in the diagram is provided in order to detect a position that is a reference of the first scanning unit 21. The position sensor may be a photo interrupter for example. In this case, signals can be detected at a position where a light shielding plate arranged in the first scanning unit 21 passes a slit portion of the photo interrupter. The control portion 30 controls rotation operations of the drive motor 38 based on detection signals from the position sensor, and is configured so as to be capable of stopping the first scanning unit 21 and the second scanning unit 22 at standby positions shown in FIG. 2A.

FIG. 3 is a system block diagram centrally showing the control portion 30 of the original reading apparatus 1 shown in FIG. 1. It should be noted that the original reading portion 2 (the image reading portion 19 of the original reading portion 2 (not shown in FIG. 3)), which is a mechanical portion of the original reading apparatus 1 shown in FIG. 2A and 2B, is connected to an image processing portion 5 in FIG. 3.

In addition to the above-mentioned original reading portion 2, the original reading apparatus 1 includes the control portion 30 and a storage portion 6. As described earlier, the original reading portion 2 is configured such that light is illuminated onto the original D, and the light reflected from the original D is guided by the image forming optical system 15 and read by the imaging device 14. The control portion 30 is provided with an original size determination portion 7, the image processing portion 5, and a communications portion 8.

The image processing portion 5 is configured such that image signals from the imaging device 14 in the image reading portion 19 undergo A/D conversion to be converted to image data, and image processing such as color conversion processing and filter processing or the like is executed on the converted image data. The image processing portion 5 is configured so as to cooperate with the original reading portion 2 to execute shading correction. Furthermore, the communications portion 8 is configured so as to carry out data communications with external devices such as an image forming apparatus and a computer or the like via an information transmission means such as a communications cable. It should be noted that the original size determination portion 7 is described in detail later.

The storage portion 6 is configured so as to temporarily store image data to be processed when the image processing portion 5 executes image processing on the image data.

Although omitted from the diagram, the control portion 30 can be configured for example from an information processing device such as a CPU, memory devices such as a ROM for storing a program that the information processing device executes, a RAM that provides a storage region for operations, and nonvolatile memories or the like that store settings for each block to carry out image processing, and an electronic circuit using an integrated circuit such as an LSI chip on which are integrated an image processing circuit block and a communication circuit block. The storage portion 6 can be configured for example using a DRAM or a memory device of another system. Furthermore, a large capacity auxiliary storage device such as an HDD or the like can be applied as the storage portion 6. It should be noted that the control portion 30 here also functions as a control portion of the original reading portion 2 and controls overall operations of the original reading portion 2.

The thus-configured original reading apparatus 1 outputs image signals of the original D that has been read by the imaging device 14 to the image processing portion 5. The image signals from the imaging device 14 undergo A/D conversion by the image processing portion 5, then image processing is executed along with shading correction. Image data to be processed is temporarily stored in the storage portion 6 when image processing is performed by the image processing portion 5. Furthermore, image data that has been processed is saved in the storage portion 6 until transfer to the external device via the communications portion 8 is completed. And the image data that has been saved in the storage portion 6 via the image processing portion 5 is transferred to the external device by the communications portion 8.

The original reading apparatus 1 according to the present embodiment is provided with the platen 27, the first scanning unit 21, the second scanning unit 22, and the control portion 30, and is further provided with original size sensors S.

As shown in FIG. 1 and FIGS. 2A and 2B, the original size sensors S are provided on the second scanning unit 22 at an area facing the platen 27. Specifically, the original size sensors S are provided on the second scanning unit 22 at an area near the platen 27 (here, the surface 224 facing the platen 27).

As shown in FIG. 2A, in a standby state before reading the original, the control portion 30 is configured to achieve a state in which the first scanning unit 21 is positioned near an upstream side of an effective original reading region a in the sub-scanning reading direction A1 (here the optical axis position from the original D of the first scanning unit 21 toward the first mirror 171 is in the sub-scanning starting position Q1) and the second scanning unit 22 is positioned near the center of the effective original reading region a in the sub-scanning direction A (here, on the upstream side in the sub-scanning reading direction A1 by half a distance between the scanning commencement end P1 and the sub-scanning starting position Q1 from a center position of the effective original reading region a in the sub-scanning direction A) and, in this state, to use the original size sensors S to carry out detection of the size of the original before reading the original.

Here the effective original reading region a refers to a region in which an image of the original D on the platen 27 can be read by the image reading portion 19, and refers to a region between the scanning commencement end P1 and the scanning completion end P2 in the sub-scanning direction A in the present example.

As shown in FIG. 2A, the above-described original reading apparatus 1 is provided with the original size sensors S on the second scanning unit 22 facing the platen 27, and therefore the original D placed on the platen 27 and the original size sensors S can be in close vicinity to each other, and this enables the size of the original to be detected with excellent accuracy. Further still, in a standby state before reading the original, a state is achieved in which the first scanning unit 21 is positioned near the upstream side of the scanning commencement end P1 in the sub-scanning reading direction A1 and the second scanning unit 22 is positioned near the center of the region a in the sub-scanning direction A between the scanning commencement end P1 and the scanning completion end P2 and, in this state, detection of the size of the original is carried out by the original size sensors S before reading the original, and therefore it is not necessary to move the scanning units 21 and 22 to detect the size of the original, and this enables a quick transition to be made to the process of reading the original D after the original D is placed on the platen 27 and the size of the original is detected.

In the present embodiment, the original size sensors S are constituted by a plurality of sensors S1 to Sn (n is an integer of one or more than one). The plurality of original size sensors S1 to Sn are arranged in a row along the second scanning unit 22 in the main scanning direction B, and carry out detection of the size of the original in the main scanning direction B. The original size sensors S1 to Sn are connected to an input system of the control portion 30 so as to send sensor output signals to the original size determination portion 7 in the control portion 30.

The original size determination portion 7 is configured so as to determine which of a predetermined plurality of different standard sizes (here, sizes in the main scanning direction B) is the size of the original in main scanning direction B for the original D placed on the platen 27 based on sensor output signals of the original size sensors S1 to Sn.

It should be noted that the original size sensors S1 to Sn here are configured as reflective type optical sensors that detect reflected light from the original D.

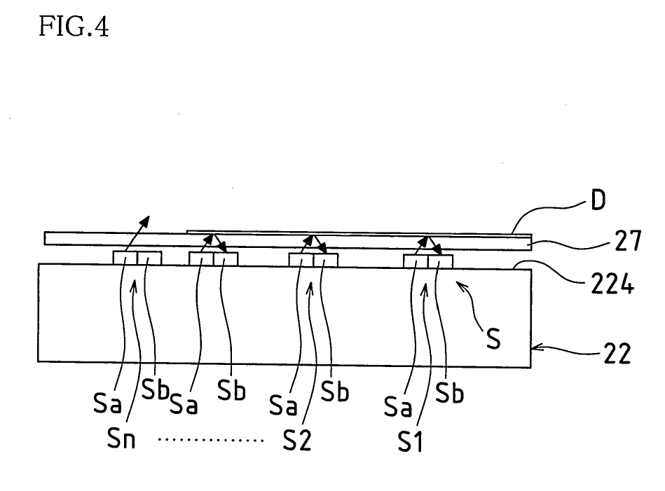

FIG. 4 is a diagram describing an operation principle of original size detection, and is an outline lateral view showing the second scanning unit 22, on which the original size sensors S1 to Sn are arranged, and the platen 27, on which the original D is placed, as viewed from one side of the sub-scanning direction A.

As shown in FIG. 4, the original size sensors S1 to Sn are each provided with an illumination portion Sa that illuminates a predetermined light (for example, infrared light), and a light-receiving portion Sb that receives reflected light from the original D. The original size determination portion 7 is configured so as to specify the size of the original based on a presence/absence of reflected light reflected by the original D from the illumination portion Sa to the light-receiving portion Sb in the original size sensors S1 to Sn.

In the original reading apparatus 1 according to the present embodiment, in the standby state before reading the original, the original size sensors S1 to Sn arranged on the second scanning unit 22 illuminate light from the illumination portion Sa to the original D placed on the original placement surface 271, and in a case where an original D is present (in a case where reflected light from the original D is received), a sensor output signal indicating “original present” (for example, an ON signal) is sent from the light-receiving portion Sb to the original size determination portion 7. On the other hand, in a case where an original D is absent (in a case where reflected light from the original D is not received), a sensor output signal indicating “no original” (for example, an OFF signal) is sent from the light-receiving portion Sb to the original size determination portion 7. The original size determination portion 7 specifies the size of the original according to the sensor output signals (for example, ON signals and OFF signals) received from the light-receiving portion Sb indicating “original present” or “no original”.

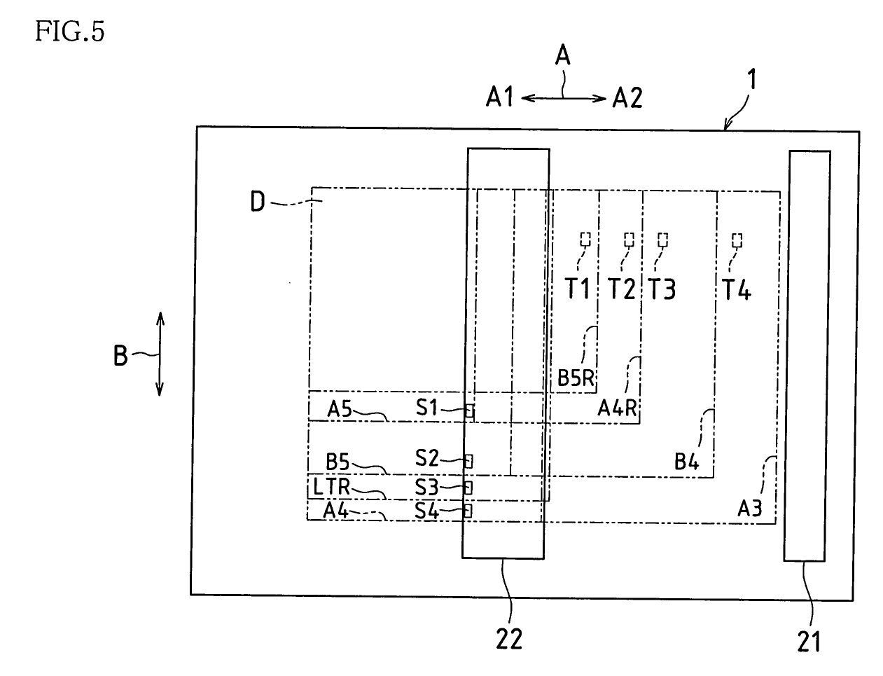

FIG. 5 is a diagram for describing specifying a size of an original and is an outline top view of a configured arrangement of original size sensors as viewed from above. It should be noted that in FIG. 5, symbols A5, B5, LTR, and A4 indicate a state in which originals D of an A5 size, B5 size, letter size, and A4 size respectively are arranged such that their lengthwise directions are along the main scanning direction B, and symbols B5R, A4R, B4, and A3 indicate a state in which originals D of a B5 size, A4 size, B4 size, and A3 size are arranged such that their lengthwise directions are along the sub-scanning direction A.

As shown in the example shown in FIG. 5, the originals D to be placed on the platen 27 are positioned using as a reference both a downstream side end of the effective original reading region a in the sub-scanning direction A1 and one side end in the main scanning direction.

In the example shown in FIG. 5, the original size sensors S1 to Sn are constituted by four sensors S1 to S4. As described earlier, the original sensors S1 to S4 are arranged on the surface 224 of the second scanning unit 22 in close vicinity to the platen 27.

It should be noted that in conventional original reading apparatuses, the original size sensors are ordinarily arranged on a bottom surface of the original reading apparatus, and since the distance between the original placed on the platen and the original size sensors is farther by that extent, it is difficult to detect with good accuracy the sizes of originals having similar sizes such as A4 size originals and letter size originals for example. In regard to this point, in the present invention the sensors S1 to S4 can perform detection close to the original D, and therefore detection can be performed with excellent accuracy even for sizes of originals D having similar sizes.

The original size sensor S1 is arranged in a position at which, in a state where the original D is arranged as shown by symbol B5R, a signal is outputted indicating “no original” (that no original D is present, same hereinafter) and, in a state of arrangements other than that, a signal is outputted indicating “original present” (that an original is present, same hereinafter).

The original size sensor S2 is arranged in a position at which, in a state where the original D is arranged as shown by symbols B5R, A5, and A4R, a signal is outputted indicating “no original” and, in a state of arrangements other than that, a signal is outputted indicating “original present”.

The original size sensor S3 is arranged in a position at which, in a state where the original D is arranged as shown by symbols B5R, A5, A4R, B5, and B4, a signal is outputted indicating “no original” and, in a state of arrangements other than that, a signal is outputted indicating “original present”.

The original size sensor S4 is arranged in a position at which, in a state where the original D is arranged as shown by symbols B5R, A5, A4R, B5, B4, and LTR, a signal is outputted indicating “no original” and, in a state of arrangements other than that, a signal is outputted indicating “original present”.

With this configuration, the original size determination portion 7 can perform determinations as shown in the following table 1.

TABLE 1

Detection results of original size sensors

| S1 | S2 | S3 | S4 | Determination |
|---|---|---|---|---|
| absent | absent | absent | absent | B5R |
| present | absent | absent | absent | A5 or A4R |
| present | present | absent | absent | B5 or B4 |
| present | present | present | absent | LTR |
| present | present | present | present | A4 or A3 |

It should be noted that “present” in table 1 indicates a detection result of “original present” and “absent” in table 1 indicates a detection result of “no original”. The same applies for table 2, which is described later.

Furthermore, the present embodiment is further provided with reflective type original size sensors T for sub-scanning direction detection (see FIG. 1 and FIG. 5) that detect the size of the original in the sub-scanning direction A. The original size sensors T are arranged on a bottom surface of the original reading apparatus 1 (here, the surface 353 of the bottom panel 352 facing the platen 27).

Specifically, the original size sensors T are constituted by a plurality of sensors T1 to Tn. The plurality of original size sensors T1 to Tn are arranged in a row on the surface 353 along the sub-scanning direction A, and carry out detection of the size of the original in the sub-scanning direction A. The number of the original size sensors T may be a different number than the number of original size sensors S that detect the size of the original in the main scanning direction B. Although omitted from the diagram in FIG. 3, the original size sensors T1 to Tn are connected to an input system of the control portion 30 so as to send sensor output signals to the original size determination portion 7 in the control portion 30. It should be noted that the original size sensors T are components that detect reflected light from the original D and are components having a configuration equivalent to the configuration of the original size sensors S. Accordingly, detailed description thereof is omitted here.

Here the original size determination portion 7 is configured so as to determine which of a predetermined plurality of different standard sizes is the size of the original for the original D placed on the platen 27 based on sensor output signals of the original size sensors S1 to Sn and the original sensors T1 to Tn.

In the example shown in FIG. 5, the original size sensors T are constituted by four sensors T1 to T4. As described earlier, the original sensors T1 to T4 are arranged on the bottom surface 353 of the original reading apparatus.

The original size sensor T1 is arranged in a position at which, in a state where the original D is arranged as shown by symbols A5, B5, LTR, and A4, a signal is outputted indicating “no original” and, in a state of arrangements other than that, a signal is outputted indicating “original present”.

The original size sensor T2 is arranged in a position at which, in a state where the original D is arranged as shown by symbols A5, B5, LTR, A4, and B5R, a signal is outputted indicating “no original” and, in a state of arrangements other than that, a signal is outputted indicating “original present”.

The original size sensor T3 is arranged in a position at which, in a state where the original D is arranged as shown by symbols A5, B5, LTR, A4, B5R, and A4R, a signal is outputted indicating “no original” and, in a state of arrangements other than that, a signal is outputted indicating “original present”.

The original size sensor T4 is arranged in a position at which, in a state where the original D is arranged as shown by symbols A5, B5, LTR, A4, B5R, A4R, and B4, a signal is outputted indicating “no original” and, in a state of arrangements other than that, a signal is outputted indicating “original present”.

With this configuration, the original size determination portion 7 can perform determinations as shown in the following table 2.

TABLE 2

| Detection results of original size sensors | | | | | | | | |
|---|---|---|---|---|---|---|---|---|
| S1 | S2 | S3 | S4 | T1 | T2 | T3 | T4 | Determination |
| absent | absent | absent | absent | present | absent | absent | absent | B5R |
| present | absent | absent | absent | absent | absent | absent | absent | A5 |
| present | absent | absent | absent | present | present | absent | absent | A4R |
| present | present | absent | absent | absent | absent | absent | absent | B5 |
| present | present | absent | absent | present | present | present | absent | B4 |
| present | present | present | absent | absent | absent | absent | absent | LTR |
| present | present | present | present | absent | absent | absent | absent | A4 |
| present | present | present | present | present | present | present | present | A3 |

It should be noted that the determinations of sizes of the original are not limited to the determinations described above.

The present invention can be embodied and practiced in other different forms without departing from the spirit and essential characteristics thereof. Therefore, the above-described embodiments are considered in all respects as illustrative and not restrictive. The scope of the invention is indicated by the appended claims rather than by the foregoing description. All variations and modifications falling within the equivalency range of the appended claims are intended to be embraced therein.

1. An original reading apparatus that reads an image of an original by optically scanning the original placed on a platen, comprising:
an original scanning portion, which is provided with a light source that optically illuminates the original on the platen and a first reflection portion that guides reflected light in a predetermined direction from the original, which has been optically illuminated by the light source, and is configured so as to move in a sub-scanning direction along the platen, and
an intermediate scanning portion, which is provided with a second reflection portion that guides reflected light of the original from the original scanning portion to an image reading portion, and is configured to operate together with sub-scanning direction movement of the original scanning portion so as to move in the sub-scanning direction along the platen,
wherein the intermediate scanning portion is provided with an original size sensor arranged so as to face the platen, and
in a standby state before reading the original, a state is achieved in which the original scanning portion is positioned near an upstream side of an effective original reading region in a sub-scanning reading direction and the intermediate scanning portion is positioned near the center of the effective original reading region in the sub-scanning direction and, in this state, detection of the size of the original is carried out by the original size sensor before reading the original.

2. The original reading apparatus according to claim 1,
wherein the original size sensor is a reflective type optical sensor that detects reflected light from an original.

3. The original reading apparatus according to claim 1,
wherein a plurality of the original size sensors are arranged in a row on the intermediate scanning portion along a main scanning direction in an area facing the platen, and carry out detection of the size of the original in the main scanning direction.

4. The original reading apparatus according to claim 1, further comprising:
a reflective type original size sensor for sub-scanning direction detection that detects the size of the original in the sub-scanning direction,
wherein the reflective type original size sensor for sub-scanning direction detection is arranged at a bottom surface of the original reading apparatus.

5. The original reading apparatus according to claim 2, further comprising:
a reflective type original size sensor for sub-scanning direction detection that detects the size of the original in the sub-scanning direction,
wherein the reflective type original size sensor for sub-scanning direction detection is arranged at a bottom surface of the original reading apparatus.

6. The original reading apparatus according to claim 3, further comprising:
a reflective type original size sensor for sub-scanning direction detection that detects the size of the original in the sub-scanning direction,
wherein the reflective type original size sensor for sub-scanning direction detection is arranged at a bottom surface of the original reading apparatus.
